(19) United States
(12) Patent Application Publication
(10) Pub. No.: US 2006/0202048 A1
(43) Pub. Date: Sep. 14, 2006

(54) Spray indication

(76) Inventors: Brian Graham, Dublin, OH (US); Michael B. Mosholder, Columbus, OH (US); James J. Lind, Westerville, OH (US); Joseph E. Zambanini, Delaware, OH (US); C. Michael Gegenheimer, Upper Arlington, OH (US); Beverly A. Piatt, Columbus, OH (US); Michael S. Ulrich, Columbus, OH (US); Andrew M. Schimmoeller, Plain City, OH (US); Jeffrey R. Held, Columbus, OH (US); John P. Tallarico, Powell, OH (US); R. Reade Harpham, Columbus, OH (US)

Correspondence Address: BATTELLE MEMORIAL INSTITUTE, 505 KING AVENUE, COLUMBUS, OH, 43201-2693, US

(21) Appl. No.: 11/363,110

(22) Filed: Feb. 27, 2006

Related U.S. Application Data
(60) Provisional application No. 60/656,411, filed on Feb. 25, 2005.

(51) Int. Cl. B05B 5/025

(52) U.S. Cl. 239/3; 239/1; 239/690; 239/71; 239/72; 239/74; 239/708

(57) ABSTRACT

A method and device are provided for providing sensory cues, signals, or indicators regarding the status of electrohydrodynamically spraying a material, including power-on status of an electrohydrodynamic spray device, active electrohydrodynamic spray status, and material status within the electrohydrodynamic spray device. In particular, audible, tactile, or intermittent visible signals indicate active electrohydrodynamic spraying, audible, tactile, or visible signals indicate power-on status of the electrohydrodynamic spray device, and sensory signals indicate the status of other operationally-related variables, including the rate of electrohydrodynamic spray, time increments, which may be correlated with electrohydrodynamic spray flowrates, and material supply levels.

### CROSS-REFERENCE TO RELATED APPLICATION(S)

This application claims priority to U.S. Prov. Pat. App. No. 60/656,411 filed Feb. 25, 2005, the contents of which are hereby incorporated herein.

### STATEMENT REGARDING FEDERALLY-SPONSORED RESEARCH OR DEVELOPMENT

Not applicable.

### INCORPORATION-BY-REFERENCE OF MATERIAL SUBMITTED ON A CD

Not applicable.

### BACKGROUND OF THE INVENTION

1. Field of the Invention

This invention relates generally to providing sensory cues, signals, or indicators regarding the application of material. Particularly, material that is difficult to see or virtually invisible or which application is difficult to hear or is virtually silent. More particularly, this invention relates to the application of liquid using electric field effect technology (EFET) spraying.

2. Description of Related Art

EFET, also known as electrohydrodynamic (EHD), spraying is a process where materials are applied, sprayed, or aerosolized using electrical forces. In a typical EHD spray nozzle, the material to be sprayed flows over a region of high electric field strength. When it does so, it receives a net electric charge that tends to stay on the surface of the material. Hence, as the material exits the nozzle, the repelling force of the surface charge balances against the surface tension of the liquid, and a so-called Taylor cone is formed. The tip of the cone has the greatest concentration of charge, and, at this point, the electrical force overcomes the surface tension, generating a thin jet of material. The jet breaks up into droplets of more or less uniform size, which collectively form a spray. The jet may also form particles, fibers, or fibrils.

The spraying of material using EHD, however, is generally virtually silent and the spray, particularly an aerosol, virtually invisible. During operation, therefore, it is desirable that a user have some indication when, in what amount, and at what rate the material is, in fact, being applied. It may be further desirable that the user have an indication of what material is being applied and where the material is being applied. It is to be understood, moreover, that the invention contemplates applying not only a single material, but more than one material, either sequentially or simultaneously, either through a common delivery outlet, or through multiple delivery outlets.

### BRIEF SUMMARY OF THE INVENTION

In one embodiment of the present invention, a method is provided for indicating the electrohydrodynamic spraying of a material comprising electrohydrodynamically spraying the material and concomitantly emitting a signal selected from the group consisting of audible, tactile, variable visible, and combinations thereof.

In a another embodiment of the present invention, a method is provided for indicating the electrohydrodynamic spraying of a material comprising electrohydrodynamically spraying the material and concomitantly emitting a periodic audible tone.

In a further embodiment of the present invention, a method is provided for indicating the electrohydrodynamic spraying of a material comprising electrohydrodynamically spraying the material, concomitantly emitting a signal selected from the group consisting of audible, tactile, variable visible, and combinations thereof, and concomitantly emitting a further signal selected from the group consisting of audible, tactile, visible, or combinations thereof.

In a yet further embodiment of the present invention, a method is provided for indicating an activation status of a device adapted to electrohydrodynamic spraying of a material and for indicating the electrohydrodynamic spraying of the material comprising electrohydrodynamically spraying the material and concomitantly emitting a signal selected from the group consisting of audible, tactile, variable visible, and combinations thereof.

In yet a further embodiment of the present invention, a method is provided for indicating the electrohydrodynamic spray rate of a material comprising emitting a sensory signal variable with the material spray rate.

In yet a further embodiment of the present invention, a method is provided for indicating the amount of material in a supply of material to an electrohydrodynamic spray device comprising emitting a sensory signal in response to an amount of material in the material supply.

In yet a further embodiment of the present invention, a method is provided for indicating a target of an electrohydrodynamic spray comprising directing a visible signal at the target.

In yet a further embodiment of the present invention, a method is provided for indicating the attributes of a material supply container of an electrohydrodynamic spray device comprising providing a device adapted to electrohydrodynamically spraying a material, providing a material supply container adapted for the device, and emitting a sensory signal in response to the material supply container.

In yet a further embodiment of the present invention, a method is provided for indicating the status of electrohydrodynamically spraying a material comprising emitting a first sensory signal, electrohydrodynamically spraying the material, and emitting a second sensory signal concomitant with the step of electrohydrodynamically spraying the material.

In yet a further embodiment of the present invention, a method is provided for indicating the status of electrohydrodynamically spraying a material comprising providing power to an electrohydrodynamic device and concomitantly emitting a first sensory signal and electrohydrodynamically spraying a material and concomitantly emitting a second sensory signal.

In yet another embodiment of the present invention, a device is provided for electrohydrodynamically spraying a material comprising a material supply, an electrohydrodynamic sprayer in material communication with the material, a first switch operably connected to a first sensory signal emitter adapted to emit a signal selected from the group consisting of audible, tactile, visible, and combinations thereof, and a second switch operably connected to the electrohydrodynamic sprayer and to a second sensory signal emitter adapted to emit a signal selected from the group consisting of audible, tactile, intermittent visible, or combinations thereof.

In yet another embodiment of the present invention, a device is provided for electrohydrodynamically spraying a material comprising a material supply, an electrohydrodynamic sprayer is communication with the material, a first switch operably connected to a sensory signal emitter, and a second switch operably connected to the electrohydrodynamic sprayer and to the sensory signal emitter.

In yet another embodiment of the present invention, a method is provided for indicating the status of an electrohydrodynamic device comprising sensing a change in the state of a switch, emitting an audible, tactile, or intermittent visible sensory signal in response to the change in state of the switch, and effecting a change in state of a circuit within the electrohydrodynamic device.

These and other features, aspects, and advantages of the present invention will become apparent upon a reading of the following detailed description of the embodiments of the invention and by reference to the following drawings.

### BRIEF DESCRIPTION OF THE SEVERAL VIEWS OF THE DRAWINGS

The following detailed description of the embodiments of the invention will be more readily understood when taken in conjunction with the following drawings, wherein:

FIG. 1 is a perspective view of a wand-like handheld device according to an embodiment of the present invention.

FIG. 2 is a perspective view of a device having an extended shaft according to another embodiment of the present invention.

FIG. 3 is a perspective view of a delivery site according to a further embodiment of the present invention.

FIG. 4 is a perspective view of a wand-like handheld device according to yet a further embodiment of the present invention.

FIG. 5 is a flowchart according to the present invention.

### DETAILED DESCRIPTION OF THE INVENTION

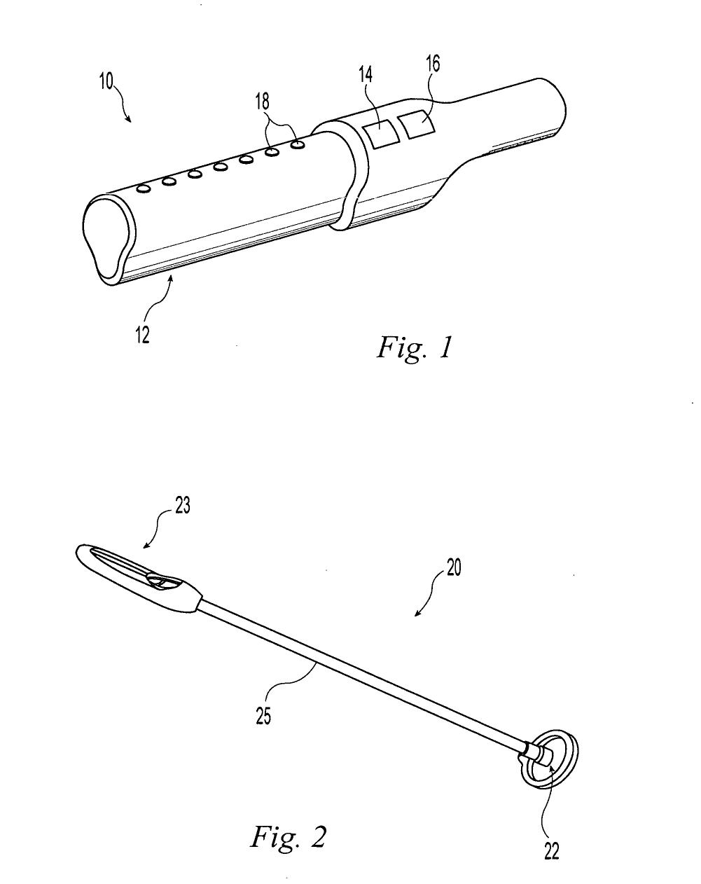

FIGS. 1-4 illustrate exemplary EHD devices which embody the present invention. It will be appreciated, however, that the illustrated devices are not intended to be inclusive of the type and variety of devices in which the present invention may be embodied.

Turning to FIG. 1, a handheld device 10 is shown which embodies elements of the present invention. The device 10 is adapted to be held in the hand of a user and moved, for example, in a wand-like fashion over the surface to be sprayed. For example, the device 10 may be used to spray an animal, such as a horse, with medicaments, pesticides, grooming aids, or other beneficial materials. The device 10 comprises one or more EHD spray sites 12 (indicated generally, but not shown), a first switch 14, an optional second switch 16, and one or more optional indicator lights 18. As will be appreciated, the switches 14, 16 may conveniently be in the form of push switches or, for example, a trigger having an “off” position, a “power-on” position, and a further “spray activation” position depending upon the degree of force applied. Optionally, or in combination, audible and tactile sensory signals (not shown) may be provided. Audible signals may include, for example, steady, intermittent, variable frequency sounds, or sounds varying in intensity. Tactile signals may include, for example, steady, intermittent, variable frequency vibrations, or vibrations varying in intensity.

Operationally, the first switch 14 may comprise a power switch which generally activates power to the device 10. Optionally, the power switch 14 may also activate a circuit which initiates EHD spraying or the second switch 16 may do so. Further, a timer may be included to, for example, activate when EHD spraying is initiated, thereby providing a method of activating a sensory signal to indicate EHD spraying is in progress as well as indicate the passage of time which may be correlated to the amount of material sprayed. As will be further appreciated, many sensory signals and combinations are possible. In general, it may be desirable to indicate the power-on state of the device 10. Thus, when the power switch 14 is closed, one or more of the indicator lights 18 may illuminate to indicate the power-on state. Concurrently, or alternatively, audible and/or tactile sensory signals may be initiated. When EHD spraying is initiated, either through the first switch 14 or the second switch 16, one or more of the indicator lights 18 may change state by, for example, blinking, changing color, or changing intensity. The indicator lights 18 may further blink sequentially to give the appearance of a moving light. As with the power-on state, audible and/or tactile sensory signals may be initiated to indicate the EHD-spraying state. As will be appreciated, multiple sensory signals may be presented concurrently or sequentially.

Turning to FIG. 2, another handheld device 20 is shown which embodies elements of the present invention. As shown, a handle 23 is separated from one or more EHD spray sites 22 (indicated generally, but not shown) by a shaft 25. The device 20 would include switches and sensory signals as convenient. For example, switches could be placed in the handle 23. Indicators (not shown) could be placed in the handle 23, anywhere on the shaft 25, or distal to the handle 23 near the one or more spray sites 22.

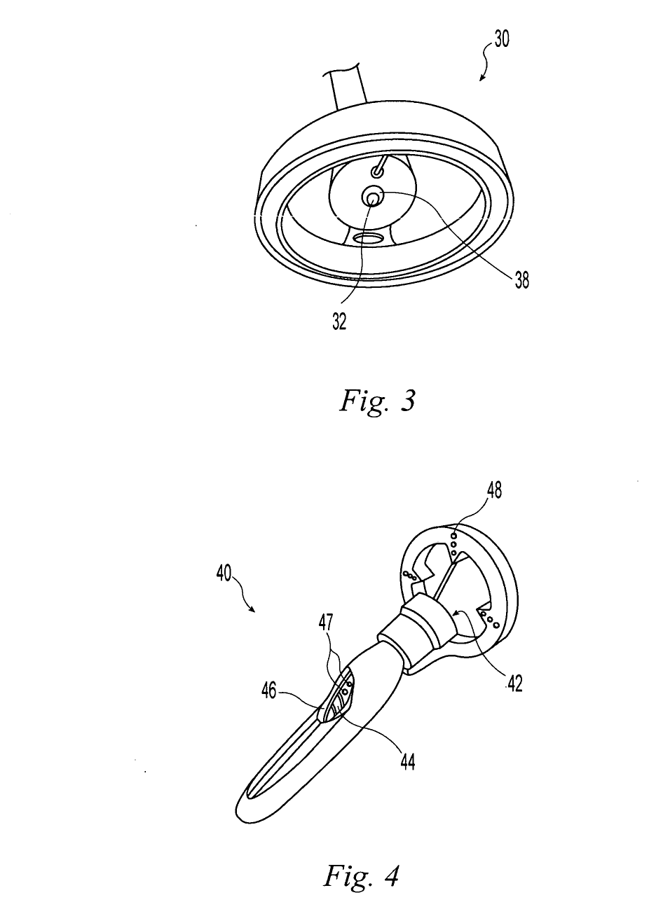

Turning to FIG. 3, a portion of a spray device 30 is shown. FIG. 3 illustrates an exemplary spray site 32 (which may comprise multiple spray sites) and indicator light 38. The indicator light 38 may comprise a light which is activated when the spray site 32 emits an EHD spray, thus illuminating the normally-invisible spray. The indicator light 38 may comprise a light that is activated before the spray site 32 begins emitting an EHD spray so as to indicate the area of the target about to be sprayed to aid in coverage. The light may be steady or may be intermittent to indicate a power-on condition and/or a spraying condition. The indicator light 38 may further comprise multiple lights of varying colors. Finally, the indicator light 38 may comprise a laser light for illumination as well as for targeting.

FIG. 4 illustrates a further embodiment of the present invention. The spray device 40 comprises a spray site 42 (indicated generally, but not shown) which may comprise one or more spray sites, a first switch 44, which may, for example, comprise a power-on-off switch, a second switch 46, which may, for example, comprise a switch to initiate EHD spraying, and indicator lights 47, 48. Optionally, the spray device 40 comprises audible and/or tactile sensory signals (not shown). The indicator lights 48 may optionally flash in a sequential manner to give the appearance of moving toward the spray site 42. For example, the indicator lights 48 may sequentially illuminate when the second switch 46 is closed to initiate EHD spraying.

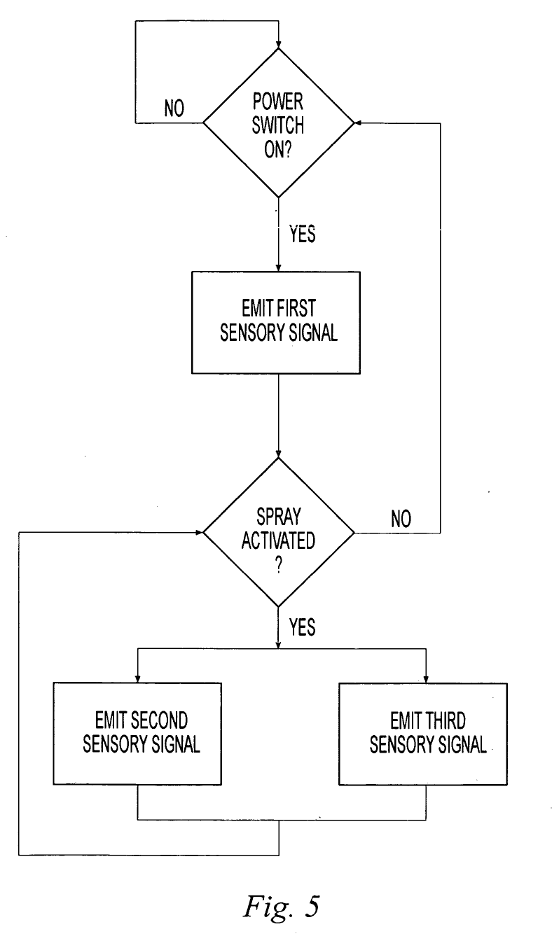

FIG. 5 is a flowchart which illustrates an embodiment of the present invention. When the power switch is set to an “on” condition, a first sensory signal is emitted. This signal indicates a power-on condition of the circuitry in the EHD device. The signal may be of any form that is detectible by the user, but preferably an audible, tactile, or visible signal. An audible signal may comprise a steady tone, a tone varying in intensity and/or frequency, an intermittent tone such as a “beeping” sound, a voice-like sound, music, or combinations thereof. A tactile signal may comprise vibrations or movements of the handle which alert the user to the power-on condition of the EHD device. Finally, a visible signal may comprise an intermittent light or one varying in intensity and/or color. Or, the visible signal need not comprise a light, but a dial or other similar indication or a portion of the device may change color in response to the EHD spray or a “smart cartridge”. Multiple signals may also be used. The nature of the signal may further be tailored to the material to be electrohydrodynamically sprayed, by, for example, a “smart” cartridge containing the material.

FIG. 5 further illustrates the indication of material being electrohydrodynamically sprayed. When EHD spraying is activated, through a switch separate from the power switch, simultaneously through the power switch itself, or, for example, through a time delay, one or more signals may be emitted. The signal may be of any form that is detectible by the user, but preferably an audible, tactile, or intermittent visible signal. The “spray-activated” signal may be emitted concomitant with the “power-on” signal or the “power-on” signal may cease or change to a different signal. As with the “power-on” signal, the nature of the signal may be tailored to the material being electrohydrodynamically sprayed to alert the user. Further, visual indication may be provided by appropriately illuminating the EHD spray. A simple on-off indication may be given, or a signal or signals responsive to the material being sprayed.

Various other embodiments of the present invention may aid in delivering an EHD spray. As pertains to the EHD spray itself, signals may indicate a particular flowrate. By way of example only, and not limitation, an audible signal may change frequency or intensity or intermittent audible signals may change tempo; similarly, a visible signal may change color or intensity or intermittent visual signals may change tempo. Tactile signals may also similarly be tailored to the application. Signals according to the present invention may be utilized to indicate, for example, when a predetermined amount of material has been sprayed or when a predetermined length of time has elapsed. Likewise, signals according to the present invention may be utilized to indicate a low level of material in a material supply container.

In addition to indications of power status and EHD spraying status, the present invention benefits the application of EHD-sprayed material by indicating the target area of the surface to be sprayed. By way of example only, and not limitation, a laser pointer or other visible light may be directed to shine off the target area.

While the present invention has been described in connection with specific exemplary embodiments, it will be appreciated by those skilled in the art that the invention is not limited to those precise embodiments and that changes and modifications may be made thereto without departing from the scope of the invention as defined by the claims. Likewise, it is to be understood that the invention is defined by the claims and it is not intended that any limitations or elements describing the exemplary embodiments set forth herein are to be incorporated into the claims unless explicitly recited in the claims themselves. Finally, it is to be understood that it is not necessary to meet any or all of the recited advantages or objects of the invention disclosed herein in order to fall within the scope of any claim, since the invention is defined by the claims and since inherent and/or unforeseen advantages of the present invention may exist even though they may not have been explicitly discussed herein.

We claim:

1. A method, comprising the steps of:
electrohydrodynamically spraying a material; and
concomitantly emitting a signal selected from the group consisting of audible, tactile, variable visible, or combinations thereof.

2. The method of claim 1, wherein:
audible signal is selected from the group consisting of steady, variable, and combinations thereof; and
tactile signal is selected from the group consisting of steady, variable, and combinations thereof.

3. The method of claim 1, wherein the emitting step comprises emitting a periodic audible tone.

4. The method of claim 1, further comprising the steps of:
terminating the electrohydrodynamic spraying of the material;
concomitantly terminating emission of the signal.

5. The method of claim 1, further comprising the step of concomitantly emitting a further signal selected from the group consisting of audible, tactile, visible, or combinations thereof.

6. The method of claim 1, further comprising the steps of:
activating a device adapted to electrohydrodynamic spraying; and
concomitantly emitting a further sensory signal.

7. The method of claim 1, further comprising the step of emitting a sensory signal variable with a material spray rate.

8. The method of claim 1, further comprising the step of emitting a sensory signal in response to an amount of the material in a material supply.

9. A method, comprising the steps of:
electrohydrodynamically spraying a material;
concomitantly directing a visible signal at the spray, whereby the spray becomes illuminated.

10. A method, comprising the steps of:
directing a visible signal at a spray target; and
electrohydrodynamically spraying a material toward the target.

11. A method, comprising the steps of:
providing a device adapted to electrohydrodynamically spraying a material;
providing a material supply container adapted for the device; and
emitting a sensory signal in response to the material supply container.

12. A method, comprising the steps of:
emitting a first sensory signal;
electrohydrodynamically spraying a liquid; and
emitting a second sensory signal concomitant with the step of electrohydrodynamically spraying the liquid.

13. A method, comprising the steps of:
providing power to an electrohydrodynamic spray device and concomitantly emitting a first sensory signal; and
electrohydrodynamically spraying a material and concomitantly emitting a second sensory signal.

14. The method of claim 13, further comprising the step of emitting a third sensory signal concomitant with electrohydrodynamically spraying the liquid.

15. A device adapted to enable the steps of claim 1.

16. A device adapted to enable the steps of claim 14.

17. A device, comprising
a material supply;
an electrohydrodynamic sprayer in communication with the material;
a first switch operably connected to a first sensory signal emitter adapted to emit a signal selected from the group consisting of audible, tactile, visible, and combinations thereof; and
a second switch operably connected to the electrohydrodynamic sprayer and to a second sensory signal emitter adapted to emit a signal selected from the group consisting of audible, tactile, intermittent visible, or combinations thereof.

18. The device of claim 17, further comprising a timer operably connected to a third sensory signal emitter.

19. The device of claim 17, further comprising a liquid flow indicator operably connected to a third sensory signal emitter.

20. A device, comprising:
a material supply;
an electrohydrodynamic sprayer in communication with the material;
a first switch operably connected to a sensory signal emitter; and
a second switch operably connected to the electrohydrodynamic sprayer and to the sensory signal emitter.

21. A method, comprising:
sensing a change in state of a switch;
emitting an audible, tactile, or intermittent visible sensory signal in response to the change in state of the switch; and
effecting a change in state of a circuit within an electrohydrodynamic device.

22. The method of claim 21, further comprising the steps of:
emitting a further sensory signal in response to the change in state of the switch; and
activating an electrohydrodynamic sprayer.

23. The method of claim 21, further comprising the steps of:
sensing a change in state of a further switch;
emitting a further sensory signal in response to the change in state of the further switch; and
activating an electrohydrodynamic sprayer.
